(19) United States
(12) Patent Application Publication
(10) Pub. No.: US 2025/0166944 A1
(43) Pub. Date: May 22, 2025

(54) Composite Elastomeric Structure

(71) Applicant: Peratech IP Ltd., Catterick Garrison, North Yorkshire (GB)

(72) Inventors: Lv BING, Suzhou Industrial Park (CN); You DAWEI, Suzhou Industrial Park (CN); Xu FENG, Suzhou Industrial Park (CN); Tang JIAJUN, Suzhou Industrial Park (CN); Wang SHICHAO, Suzhou Industrial Park (CN); Zhang WEN, Suzhou Industrial Park (CN); Wei XIN, Suzhou Industrial Park (CN); Li ZEFENG, Suzhou Industrial Park (CN)

(21) Appl. No.: 18/839,840

(22) PCT Filed: Feb. 21, 2023
(86) PCT No.: PCT/GB2023/000007

§ 371 Date: Aug. 20, 2024

(30) Foreign Application Priority Data
Feb. 21, 2022 (CN) 2022 20354524.0

(51) Int. Cl. H01H 13/704; H01H 13/7065

(52) U.S. Cl. CPC H01H 13/704; H01H 13/7065; H01H 2221/08; H01H 2221/084; H01H 2227/03

(57) ABSTRACT

A composite elastomeric structure comprises an elastic body comprising a top structure and a ring side wall structure and a transmitting column comprising an outer shell structure and an inner core structure. The transmitting column is connected to the top structure and is located below the top structure in a substantially central position. The ring side wall structure is connected to the top structure and surrounds the transmitting column and is located below the top structure. The outer shell structure comprises a material having a first hardness and the inner core structure comprises a material having a second hardness. The first hardness is smaller than the second hardness.

### CROSS REFERENCE TO RELATED APPLICATIONS

This application claims priority from Chinese Utility Model number 2022 20 354 524.0, filed on 21 Feb. 2022, the whole contents of which are incorporated herein by reference.

### TECHNICAL FIELD

The present invention relates to a composite elastomeric structure and a button comprising a composite elastomeric structure, such as those used in the technical field of keyboard keys.

### BACKGROUND OF THE INVENTION

As one of the main output devices of the computer, the keyboard is an important carrier of human-computer interaction. In order to meet the development trend of thinner and lighter devices and keyboards, existing notebook and laptop keyboards usually adopt a thin-film scissor switch structure.

The structure is mainly comprised of a pair of scissor legs, a structure having an elastic body, and a keycap. The elastic body structure has a major impact on the pressing feel of the keyboard keys due to its own characteristics.

At present, the elastic body structure is integrally formed from a rubber material. Existing elastic body structure designs typically reduce the hardness of the elastic body as much as possible in order to maintain a relatively soft feel and response for a user when pressing the keyboard keys.

However, this solution is not conducive to the transfer of the pressing force to the keyboard film through the elastic body structure. Consequently, it is not suitable in the application of relatively new pressure-sensing keyboard keys. With the development of technology, users have increased requirements for notebook key functions. In order to address these desires, many manufacturers have introduced pressure-sensitive keyboards which are detected by pressure-sensing modules. Such pressure-sensing modules take the size of the user's pressing force on the key and convert it into a corresponding control command to achieve multiple functions with one key.

Therefore, the elastic body structure transmits a pressing force to the keyboard film. Thus, the force transmission efficiency is very important in improving the performance of such a pressure-sensing key.

The present application seeks to provide a composite elastomeric structure and keys to solve the problem that the existing elastic body structure is formed integrally with a rubber material with relatively low hardness, which is not conducive to the transmission of pressing force to the keyboard film through the elastic body structure.

### BRIEF SUMMARY OF THE INVENTION

According to a first aspect of the present invention, there is provided a composite elastomeric structure, as claimed in claim 1.

In this technical solution, the composite elastomeric structure may be elastically deformed under the action of a keycap, so that the elastic body, the top structure, and the transmitting column gradually move downwards. Due to the elastic deformation of the composite elastomeric structure itself and the limitation of the internal space within a keyboard, the ring side wall structure is deformed correspondingly due to the applied force, so that the ring side wall structure also contacts the keyboard's membrane beneath the composite elastomeric structure.

When formed as part of a keyboard, the transmitting column is the main carrier in contact with the keyboard membrane. The inner core structure of the transmitting column has a greater hardness than the outer shell structure which ensures the transmission of applied force is maximized and less force is lost due to the deformation of the transmitting column. This improves the force-displacement characteristics and is suitable for applications with pressure-sensing keyboard keys. At the same time, the outer shell structure of the transmitting column is made of softer materials, which ensures that the user has better feel of the pressing force when pressing the key.

In some optional embodiments, the outer shell structure has an opening for placing the inner core structure therein, and the outer shell structure is detachably connected to the inner core structure. In this technical solution, the detachable connection between the outer shell structure and the inner core structure of the transmitting column means the inner core structure can be easily replaced with structures comprising different hardness materials so as to match any use requirements for pressing feel and force-displacement characteristics of the composite elastomeric structure.

In some optional embodiments, a top end of the composite elastomeric structure has a concave portion. In this technical solution, the concave portion at the top of the elastic body can provide more buffer space for the downward movement of the transmitting column, so that the downward movement of the composite elastomeric structure removes the limitation of keyboard space and increases the downward movement.

According to a second aspect of the present invention, there is provided a composite elastomeric structure, as claimed in claim 12.

According to a third aspect of the present invention, there is provided a button, comprising: the composite elastomeric structure of any preceding claim, a keycap, a substrate and a connecting structure.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an electronic device comprising a keyboard comprising a composite elastomeric structure of the present invention;

FIG. 2 shows a schematic diagram of a composite elastomeric structure according to a first embodiment of the present invention;

FIG. 3 shows a schematic diagram of a composite elastomeric structure according to a second embodiment of the present invention;

FIG. 4 shows a schematic structural diagram of a button according to an embodiment of the present invention;

FIG. 5 shows a schematic diagram of a composite elastomeric structure according to a third embodiment of the present invention;

FIG. 6 shows a schematic diagram of a composite elastomeric structure according to a fourth embodiment of the present invention;

FIG. 7 shows a schematic structural diagram of a button according to a further embodiment of the present invention; and

FIG. 8 shows a schematic diagram of a composite elastomeric structure provided by a fifth embodiment of the present invention.

### DETAILED DESCRIPTION OF EMBODIMENTS OF THE INVENTION

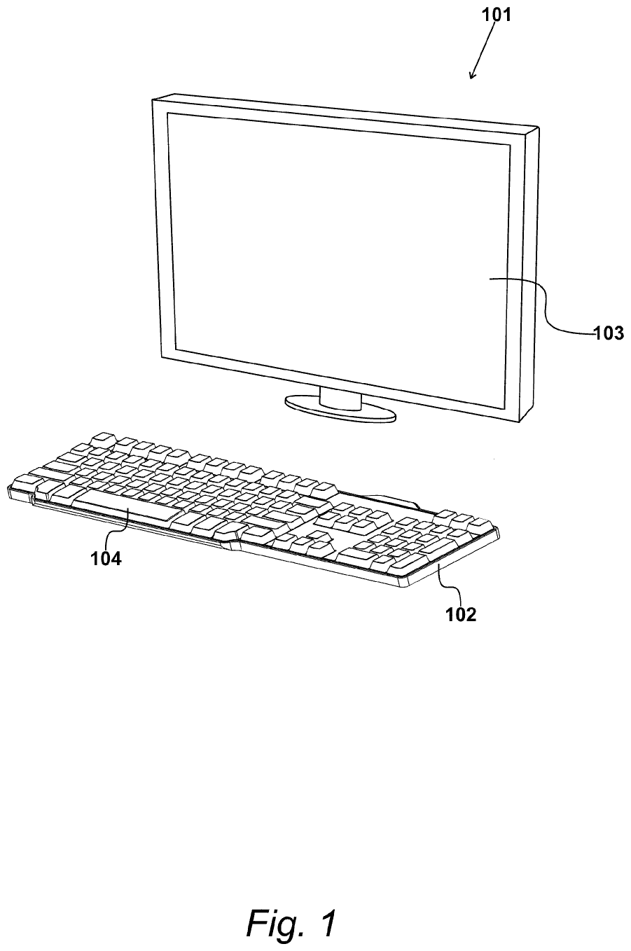

FIG. 1

An electronic device in the form of a personal computer is shown in FIG. 1. It is appreciated that alternative electronic devices which comprise electronic keyboards for providing inputs may be utilized in accordance with the invention.

Electronic device 101 comprises a keyboard 102 and a display 103. Keyboard 102 comprises a plurality of buttons 104, which may be utilized to control input into electronic device 101. In accordance with an aspect of the invention, each button 104 comprises a composite elastomeric structure as will be described herein. Each button is positioned above a keypad membrane of the keyboard which connects each of the buttons in electronic keyboard 102.

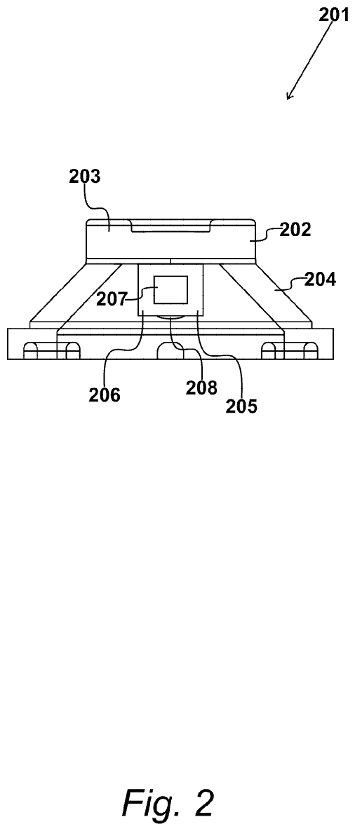

FIG. 2

FIG. 2 shows a composite elastomeric structure provided by a first embodiment of the present invention. Composite elastomeric structure 201 comprises an elastic body 202 comprising a top structure 203 and a ring side wall structure 204. Composite elastomeric structure 201 further comprises a transmitting column 205 comprising an outer shell structure 206 and an inner core structure 207.

Transmitting column 205 is connected to top structure 203, and is located in a substantially central position of the composite elastomeric structure 201, below top structure 203. Ring side wall structure 204 is connected to top structure 203 and is located below top structure 203. Ring side wall structure 204 further surrounds transmitting column 205.

In the embodiment, outer shell structure 206 comprises a material having a first hardness and inner core structure 207 comprises a material having a second hardness. In the embodiment, the first hardness is smaller than the second hardness. For example: the first hardness is a hardness value less than or equal to a Shore hardness of 50, and the second hardness has a value greater than a Shore hardness of 50.

In the present embodiment, the composite elastomeric structure 201 comprises elastic body 202 and transmitting column 205. Elastic body 202 comprises top structure 203 and ring side wall structure 204. When utilized in an embodiment comprising an electronic keyboard and plurality of buttons, composite elastomeric structure 201, forming part of the button, is stressed under the action of a keycap to generate elastic deformation, such that top 20 structure 203 of elastic body 202 and transmitting column 205 gradually move downwards. Due to the elastic deformation of the composite elastomeric structure itself and the limitation of the internal space within the keyboard, ring side wall structure 204 is deformed correspondingly due to the force applied. Ring side wall structure 204 is thus also in contact with the keypad membrane 25 of the keyboard which is positioned below the composite elastomeric structure.

Transmitting column 205 is connected to top structure 203 and is located at the center below top structure 203. Transmitting column 205 is the main carrier for contacting the keyboard membrane of keyboard 102. Inner core structure 207 of transmitting column 205 has a second hardness which is higher than that of the outer shell structure 206 meaning the composite elastomeric structure suffers less force loss due to the deformation of the transmitting column 205. This consequently improves the force-displacement characteristic and is suitable for the application of buttons on pressure-sensing keyboards. The result also provides a better pressing feel for a user when pressing the button.

In some optional embodiments, elastic body 202 and outer shell structure 206 are made of the same material and elastic body 202 and transmitting column 205 are integrally molded by a two-shot injection molding process. In an example embodiment, inner core structure 207 is used as an insert in an insert molding process to integrally form elastic body 202 and transmitting column 205. Thus, composite elastomeric structure is obtained by a one-piece forming process.

In the embodiment, elastic body 202 and outer shell structure 206 of transmitting column 205 are made of the same material, and the following two processes can be used to make the composite elastomeric structure.

In one example, composite elastomeric structure is double-injected in a two-shot injection molding process. Taking elastic body 202 and outer shell structure 206 as a whole, softer and harder silicone rubber is injected into elastic body 202 and outer shell structure 206 through a first material tube through an injection mold. With elastic body 202 and outer shell structure 206 remaining in the injection mold, relatively hard silicone is injected into the two-shot mold through a second material tube to form inner core structure 207 of transmitting column 205.

The structure shown in FIG. 2 can also be formed through an insert molding process. First, inner core structure 207 is made as an insert. In addition to using silicone rubber materials, the insert can also comprise TPE (thermoplastic elastomer), PET (polyethylene terephthalate, polyester resin), TPU (thermoplastic polyurethane) and other materials with higher hardness and lower deformation. Any such insert is placed into the mold of the composite elastomeric structure, and subsequently melted into the mold of the composite elastomeric structure, and, in turn the inserts join and solidifies to form the composite elastomeric structure described herein.

In an embodiment, in which elastic body 202 comprises a material having a third hardness, the third hardness is less than the first hardness of outer shell structure 206. For example, the first hardness has value less than or equal to 50 Shore hardness and greater than 40 Shore hardness. In this example, the third hardness has a hardness value of less than or equal to 40 Shore hardness. In the embodiment, inner core structure 207 is obtained through a two-shot injection molding process, or alternatively is integrally formed by an insert molding process in which the inner core structure 207 as an insert, to form transmitting column 205 and elastic body 202.

In an embodiment, inner core structure 207 is made of a harder and less deformable material, for example: TPE (thermoplastic elastomer); PET (polyethylene terephthalate, polyester resin); TPU (thermoplastic polyurethane) or similar.

As an insert, elastic body 202 is formed by injecting softer and harder silicone rubber through an A material tube through an injection mold. After molding, the insert is placed in the first injection mold, and then elastic body 202 left in the first injection mold. The relatively hard silicone is then injected through the B material tube into a two-shot mold to form the transmitting column 205 with the insert.

Therefore, in this embodiment, inner core structure 207 has a second hardness, outer shell structure 206 has a first hardness, elastic body 202 has a third hardness. Further, the hardness of outer shell structure 206 has a value between the second hardness and the third hardness. Thus, when a user presses a button comprising the composite elastomeric structure, the force loss of the composite elastomeric structure due to the deformation of the transmitting column 205 is further reduced and the force-displacement characteristic is further improved. Thus, the arrangement is suitable in the application of new pressure-sensing keyboard keys.

In some optional embodiments, inner core structure 207 includes a raised portion 208 protruding from the bottom of outer shell structure 206. Raised portion 208 is used to contact a piezoresistive film sensor for detecting the pressing or applied force from a user pressing a button on keyboard 102.

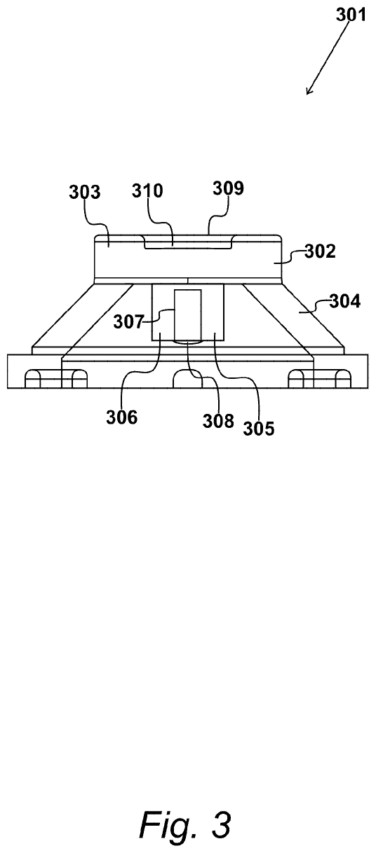

FIG. 3

A further example embodiment as an alternative to the composite elastomeric structure of FIG. 2, is shown in FIG. 3.

Composite elastomeric structure 301 comprises an elastic body 302 comprising a top structure 303 and a ring side wall structure 304. Composite elastomeric structure 301 further comprises a transmitting column 305 comprising an outer shell structure 306 and an inner core structure 307.

Transmitting column 305 is connected to top structure 303, and is located in a substantially central position of the composite elastomeric structure 301, below top structure 303. Ring side wall structure 304 is connected to top structure 303 and is located below top structure 303. Ring side wall structure 304 further surrounds transmitting column 305.

Composite elastomeric structure 301 is substantially similar to the embodiment of FIG. 2 save for the following differences. In this embodiment, outer shell structure 306 of this embodiment has an opening for placing the inner core structure 307. Outer shell structure 306 is detachably connected to the inner core structure 307.

Inner core structure 307 may be provided with different hardness materials which can be selected to match the demand for the pressing feel of the composite elastomeric structure and the force-displacement characteristic requirements such that the composite elastomeric structures are operable under different working conditions.

In some optional embodiments, an opening is located at the bottom of the outer shell structure 306, and inner core structure 307 includes a raised portion 308. Raised portion 308 is used to contact a piezoresistive film sensor for detecting the pressing force applied by a user.

In an embodiment, elastic body 302 and outer shell structure 306 are made of the same material, and elastic body 302 and outer shell structure 306 are integrally formed.

In the embodiment, elastic body 302 and outer shell structure 306 of transmitting column 305 are integrally formed, and the integrally formed structure is detachably connected to inner core structure 307. Compared with the integrally formed structure of the elastic body 302 and outer shell structure 306, inner core structure 307 has a higher hardness which ensures that composite elastomeric structure loses less force due to the deformation of transmitting column 305, thereby improving the force-displacement characteristics and thus is suitable for the application of pressure-sensing keyboard keys.

In some optional embodiments, elastic body 302 has a third hardness, and the third hardness is smaller than the first hardness, and elastic body 302 and outer shell structure 306 are integrally formed by a double-shot injection molding process or an insert molding process, which may be substantially similar to that described with respect to FIG. 2.

In some optional embodiments, a top end 309 of elastic body 302 has a concave recessed portion 310.

Recessed concave portion 310 positioned at the top of elastic body 302 provides more buffer space for transmitting column 305 to go downwards, such that the downward travel of the composite elastomeric structure reduces the limitation of the keyboard space and increases the additional force transmission travel.

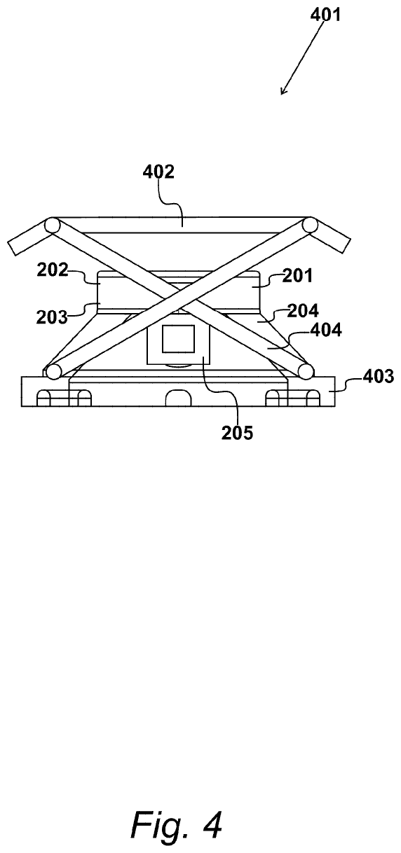

FIG. 4

A schematic structural diagram of a button which can be utilized with the composite elastomeric structures of FIG. 2 or 3 is shown in FIG. 4.

Button 401 comprises the composite elastomeric structure 201 or 301 (indicated 201 in the drawing for simplicity), keycap 402, substrate 403 and a connecting structure 404.

In the embodiment, keycap 402 is arranged above composite elastomeric structure 201 and substrate 403 is arranged below composite elastomeric structure 201. Connecting structure 404 is used for connecting keycap 402 and substrate 403.

In the embodiment, the composite elastomeric structure adopted by the button is comprised of elastic body 202 and transmitting column 205. Elastic body 202 has a top structure 203 and ring side wall structure 204. Composite elastomeric structure 201 acts on keycap 402 under an applied force from a user press. This produces elastic deformation, so that top structure 203 of elastic body 202 and transmitting column 205 gradually move downwards. Due to the elastic deformation of the composite elastomeric structure itself and the limitation of the internal space of the keyboard, ring side wall structure 204 is subjected to force. A corresponding deformation takes place so that ring side wall structure 204 also comes into contact with the keyboard membrane below composite elastomeric structure 201.

Transmitting column 205 is connected to top structure 202 and is located substantially at the center below the top structure 202. Transmitting column 205 is the main carrier for contacting the keyboard membrane. Inner core structure 207 of transmitting column 205 has a second hardness which has a higher value of hardness, meaning the composite elastomeric structure has reduced force loss due to the deformation of the transmitting column 205, thereby improving the force-displacement characteristic and is consequently suitable for the application of pressure-sensing keyboard keys. This further gives an improved pressing feel for a user when pressing the button.

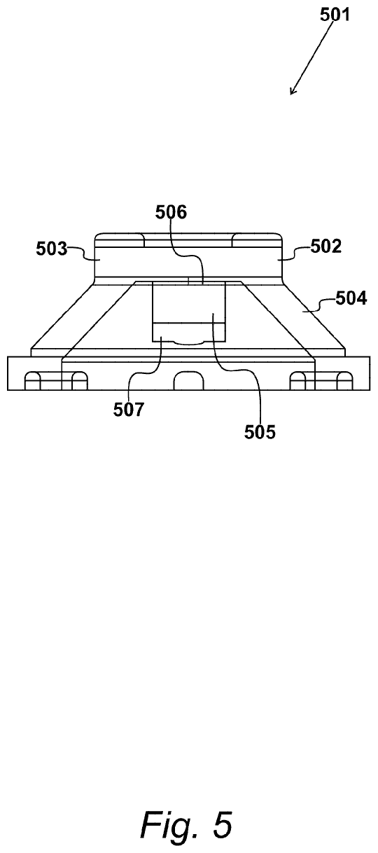

FIG. 5

A composite elastomeric structure 501 provided by an alternative embodiment of the present invention comprises an elastic body 502 comprising a top structure 503, a ring side wall structure 504 and a transmitting column 505.

Transmitting column 505 is connected to top structure 503 and is located substantially in a central position below top structure 503.

Ring side wall structure 504 is connected to top structure 503, and is located below top structure 503. Further, ring side wall structure 504 surrounds transmitting column 505.

In the embodiment, transmitting column 505 comprises a proximal end 506 adjacent to top structure 503 and a distal end 507 extending away from top structure 507. Proximal end 506 has a first hardness, and distal end 507 has a second hardness; the first hardness is smaller than the second hardness.

In an example embodiment, the first hardness is less than or equal to 50 Shore hardness, and the second hardness is greater than 50 Shore hardness.

In the embodiment, composite elastomeric structure 501 is comprised of elastic body 502 and transmitting column 505. Elastic body 502 has a top structure 503 and a ring side wall structure 504. Composite elastomeric structure 501 is activated under the force of a keycap. In this way, elastic deformation makes top structure 503 of elastic body 502 and transmitting column 505 gradually move downwards. Due to the elastic deformation of composite elastomeric structure 501 itself and the limitation of the internal space of the keyboard, ring side wall structure 504 is deformed correspondingly due to the pressing force applied, such that ring side wall structure 504 also contacts the keyboard membrane under composite elastomeric structure 501.

Transmitting column 505 is connected to top structure 503 and is located at the center below top structure 503. Transmitting column 505 is the main carrier for contacting the keyboard membrane in a keyboard. In this way, composite elastomeric structure 501 has reduced force loss due to the deformation of the transmitting column 505, which improves the force-displacement characteristic and is suitable for the application of pressure-sensing keyboard keys. The arrangement further improves the pressing feel for a user when pressing the button.

In some optional embodiments, elastic body 502 and proximal end 506 of transmitting column 505 are made of the same material and composite elastomeric structure 501 is obtained by an insert molding process.

In an embodiment, elastic body 502 and proximal end 506 of transmitting column 505 are made of the same material, meaning the following two processes can be used to make the composite elastomeric structure. The first process utilizes a two-shot injection molding process, as described previously in respect to FIG. 2. For composite elastomeric structure 501 shown, with elastic body 502 and proximal end 506 as a whole, softer and harder silicone rubber is injected through an A material tube to form elastic body 502 and proximal end 506. Elastic body 502 and proximal end 506 will be left in the injection mold which is closed with a second injection mold, following which relatively hard silicone is injected into the second injection mold through a B material tube to form the distal end 507 of transmitting column 505.

The second process adopts an insert molding process. Composite elastomeric structure 501 is made by utilizing distal end 507 as an insert. In addition to using silicone rubber materials, it is appreciated that, other materials including TPE (thermoplastic elastomer), PET (polyethylene terephthalate, polyester resin) TPU (thermoplastic polyurethane) and other materials with higher hardness and less deformation can also be used for the insert.

Such inserts are inserted into the mold with the composite elastomeric structure, and the silicone rubber and composite elastomeric structure are melted in the mold. This allows the components to bond. The bonding is then cured to form the composite elastomeric structure.

In some optional embodiments, elastic body 502 has a third hardness, and the third hardness is smaller than the first hardness. Distal end 507 is obtained through an injection mold process, and transmitting column 505 and elastic body 502 are integrally formed through a double-shot injection molding process.

In an example embodiment, the first hardness is less than or equal to 50 Shore hardness and greater than 40 Shore hardness, and the third hardness is less than or equal to 40 Shore hardness.

In an embodiment, distal end 507 is made of a harder and less deformable material, such as, for example, TPE (thermoplastic elastomer), PET (polyethylene terephthalate, polyester resin) TPU (thermoplastic polyurethane) or any other suitable material. For the insert, elastic body 502 is formed by injecting the softer and harder silicone rubber or other material through a material tube A through an injection mold. The part is molded with the two-shot molding process, and then relatively hard silicone is injected into the two-shot mold through a B material tube to form the transmitting column 505 with the insert.

Therefore, in this embodiment, distal end 507 has a second hardness, proximal end 506 has a first hardness, and elastic body 502 has a third hardness. The hardness of the proximal end 506 is between the second hardness and the third hardness. This arrangement works to maintain an improved pressing feel for a user and the force lost by the composite elastomeric structure due to the deformation of transmitting column 505 is reduced meaning the force-displacement characteristic is improved, such that the composite elastomeric structure described is suitable for the application of pressure-sensing keyboard keys.

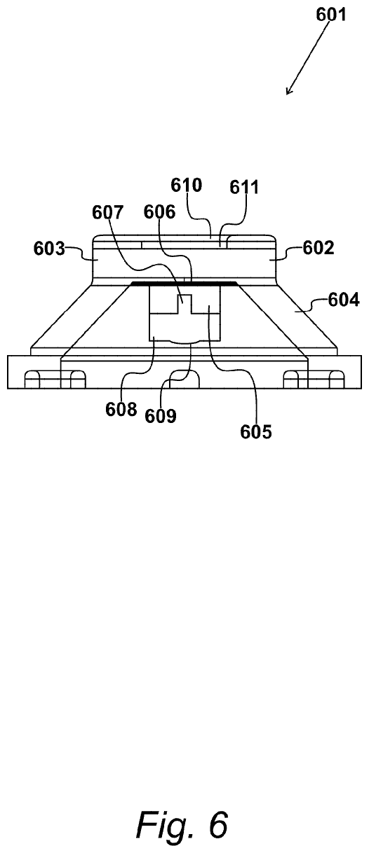

FIG. 6

FIG. 6 shows a schematic diagram of a composite elastomeric structure 601 provided by another embodiment of the present invention. Composite elastomeric structure 601 comprises an elastic body 602 comprising a top structure 603, a ring side wall structure 604 and a transmitting column 605.

A proximal end 606 of transmitting column 607 has a mounting portion 607, and mounting portion 607 is used to detachably connect distal end 608.

In the embodiment, the detachable connection between proximal end 606 and distal end 608 of transmitting column 607 means that distal end 608 can be easily provided with materials having different hardness, so as to match any pressing feel requirements and force-displacement characteristic requirements under different working conditions.

In some optional embodiments, one of mounting portion 607 and distal end 608 includes at least one mounting socket, the other of which includes at least one corresponding mounting plug. Thus, the mounting socket and the mounting plug are arranged correspondingly.

In the embodiment, at least one pair of mounting plugs and mounting sockets are provided at the proximal end 606 and the remote end 608 to realize the detachable connection of the two.

In some optional embodiments, elastic body 602 and proximal end 606 of transmitting column 607 are made of the same material, and elastic body 602 and proximal end 606 of transmitting column 607 are integrally formed.

In the embodiment of the present application, elastic body 602 is integrally formed with proximal end 606 of transmitting column 607, and the integrally formed structure is detachably connected to distal end 608. Compared with the integrally formed structure, distal end 608 has a higher hardness which can make the composite elastomeric structure 601 lose less force due to the deformation of transmitting column 607, thereby improving the force-displacement characteristic making it suitable for the application of pressure-sensing keyboard keys.

In some optional embodiments, elastic body 602 has a third hardness, and the third hardness is smaller than the first hardness. In this embodiment, elastic body 602 and proximal end 606 of transmitting column 607 are integrally formed by a double-shot injection molding process, substantially similar to that described previously herein.

In some optional embodiments, distal end 608 of transmitting column 607 includes a raised portion 609. Raised portion 209 is used to contact a piezoresistive film sensor in a keyboard for detecting the applied pressing force.

In some optional embodiments, the top structure 610 of elastic body 602 has a concave portion 611.

In the embodiment, the recessed concave portion 611 of elastic body 602 provides more buffer space for transmitting column 607 to go downwards, so that the downward travel of the composite elastomeric structure is not limited by the keyboard space and additional transmission travel can be increased.

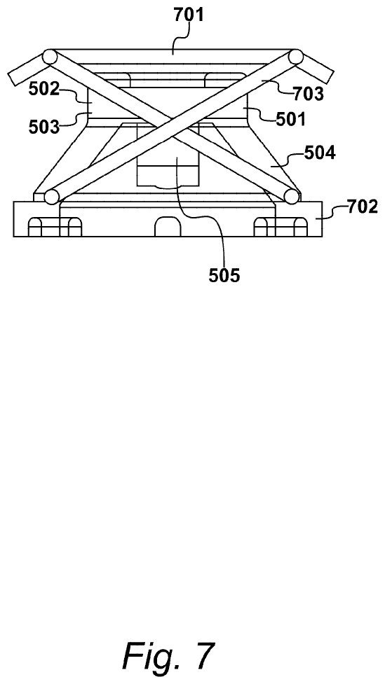

FIG. 7

FIG. 7 shows a structural schematic diagram of a button provided by a further embodiment of the present invention. The button includes a composite elastomeric structure such as composite elastomeric structure 501 or composite elastomeric structure 601, as well as a keycap 701, a substrate 702 and a connecting structure 703.

In the embodiment, keycap 701 is arranged above the composite elastomeric structure 501, 601 (hereinafter 501 for simplicity) and substrate 702 is arranged under composite elastomeric structure 501. Connecting structure 703 is used for connecting keycap 701 and substrate 702.

In the embodiment, composite elastomeric structure 501 adopted by the button comprises elastic body 502 and transmitting column 505. Elastic body has a top structure 503 and a ring side wall structure 504.

When a force is applied to keycap 701, the applied pressing force produces elastic deformation, so that top structure 503 of elastic body 502 and transmitting column 505 gradually move downwards. Due to the elastic deformation of the composite elastomeric structure 501 itself and the limitation of the internal space of the keyboard, ring side wall structure 504 responds to the force by deforming. In this way, ring side wall structure 504 also contacts the keyboard membrane under composite elastomeric structure 501.

Transmitting column 505 is connected to top structure 503 and is located in a central position below top structure 503. Transmitting column 505 is the main carrier for contacting the keyboard membrane. Thus, the composite elastomeric structure 501, 601 has less force loss due to the deformation of the transmitting column 505, 607, which improves the force-displacement characteristics and is suitable for the application of pressure-sensing keyboard keys while giving a user an improved pressing feel when pressing the button.

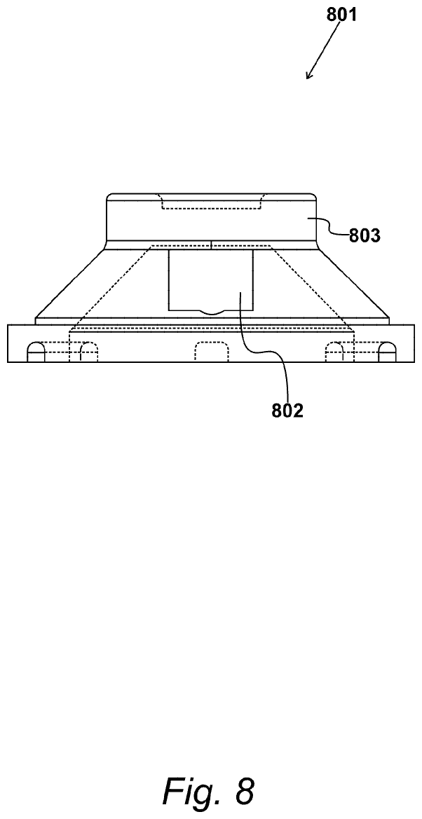

FIG. 8

A further schematic example embodiment is shown in FIG. 8. In this embodiment, composite elastomeric structure 801 comprises a transmitting column 802 with a second hardness and an elastic body 803 with a first hardness.

The transmitting column 802 and the elastic body 803 are integrally formed by a double-shot injection molding process.

In the embodiments provided in this application, it should be understood that the disclosed devices and methods may be implemented in other ways. The device embodiments described above are only illustrative. For example, multiple units or components can be combined or may be integrated into another system, or some features may be ignored, or not implemented.

In addition, a unit described as a separate component may or may not be physically separated, and a component displayed as a unit may or may not be a physical unit, that is, it may be located in one place, or may be distributed to multiple network units. Furthermore, each unit in each embodiment may be integrated to form an independent part, each unit may exist independently, or two or more units may be integrated to form an independent part.

1. A composite elastomeric structure forming part of a button of an electronic keyboard, said button further comprising a keycap and said composite elastomeric structure comprising:
an elastic body comprising a top structure and a ring side wall structure; and
a transmitting column comprising an outer shell structure and an inner core structure; wherein
said transmitting column is connected to said top structure and is located below said top structure in a substantially central position;
said ring side wall structure is connected to said top structure and surrounds said transmitting column and is located below said top structure; and
elastic deformation of said composite elastomeric structure is generated on application of a force to said keycap such that said top structure and said transmitting column move downwards and said ring side wall structure deforms due to the force applied;
said outer shell structure comprises a material having a first hardness and said inner core structure comprises a material having a second hardness; and
said first hardness is smaller than said second hardness.

2. The composite elastomeric structure of claim 1, wherein said elastic body and said outer shell structure are made of a same material.

3. The composite elastomeric structure of claim 1, wherein said elastic body and said transmitting column are integrally formed by a two-shot injection molding process.

4. The composite elastomeric structure of claim 1, wherein said elastic body and said transmitting column are integrally formed by an insert molding process.

5. The composite elastomeric structure of claim 1, wherein said elastic body comprises a material having a third hardness, and said third hardness is smaller than said first hardness.

6. The composite elastomeric structure of claim 1, wherein said inner core structure comprises a raised portion protruding from a bottom end of said outer shell structure, and said raised portion is used to contact a piezoresistive film sensor for detecting a pressing force.

7. The composite elastomeric structure of claim 1, wherein the outer shell structure has an opening for placing said inner core structure, and said outer shell structure is detachably connected to said inner core structure.

8. The composite elastomeric structure of claim 7, wherein said opening is located at a bottom of outer shell structure, said inner core structure comprises a raised portion, and said raised portion is used to contact a piezoresistive film sensor for detecting a pressing force.

9. The composite elastomeric structure of claim 7, wherein said elastic body and said outer shell structure are made of a similar material, and said elastic body and said outer shell structure are integrally formed.

10. The composite elastomeric structure of claim 7, wherein said elastic body comprises a material having a third hardness, said third hardness is smaller than said first hardness, and said elastic body and said outer shell structure are integrally formed by a two-shot injection molding process.

11. The composite elastomeric structure of claim 1, wherein a top end of said elastic body has a concave portion.

12. A composite elastomeric structure forming part of a button of an electronic keyboard, said button further comprising a keycap and said composite elastomeric structure comprising:
an elastic body comprising a top structure and a ring side wall structure; and
a transmitting column connected to said top structure and located below said top structure in a substantially central position; wherein
said ring side wall structure is connected to said top structure and surrounds said transmitting column and is located below said top structure; and
elastic deformation of said composite elastomeric structure is generated on application of a force to said keycap such that said top structure and said transmitting column move downwards and said ring side wall structure deforms due to the force applied;
said transmitting column comprises a proximal end close to said top structure and a distal end away from said top structure;
said proximal end comprises a material having a first hardness, and said distal end comprises a material having a second hardness; and
said first hardness is smaller than said second hardness.

13. The composite elastomeric structure of claim 12, wherein said elastic body and said proximal end of said transmitting column comprise a same material.

14. The composite elastomeric structure of claim 13, wherein said elastic body and said transmitting column are integrally formed through a two-shot injection molding process.

15. The composite elastomeric structure of claim 13, wherein said elastic body and said transmitting column are integrally formed through an insert molding process by using said distal end as an insert to obtain said composite elastomeric structure.

16. The composite elastomeric structure of claim 12, wherein said elastic body comprises a material having a third hardness, and said third hardness is smaller than said first hardness.

17. The composite elastomeric structure of claim 12, wherein said proximal end of said transmitting column comprises a mounting portion, and said mounting portion is used for detachably connecting said distal end.

18. The composite elastomeric structure of claim 17, wherein one of said mounting portion and said distal end comprises at least one mounting socket, the other of said mounting portion and said distal end comprises at least one mounting plug; and said at least one mounting socket is set correspondingly to said at least one mounting plug.

19. The composite elastomeric structure of claim 17, wherein said elastic body comprises substantially a same material as said proximal end of said transmitting column, and said elastic body is integrally formed with said proximal end of said transmitting column.

20. The composite elastomeric structure of claim 17, wherein said elastic body comprises a material having a third hardness, and said third hardness is smaller than said first hardness; and
said elastic body passes through said proximal end of said transmitting column to form a one-piece molding by a two-shot injection molding process.

21. The composite elastomeric structure of claim 16, wherein said distal end of said transmitting column comprises a raised portion; and said raised portion is used to contact a piezoresistive film sensor for detecting a pressing force.

22. The composite elastomeric structure of claim 12, wherein said top structure of said elastic body has a concave portion.

23. A button, comprising:
the composite elastomeric structure of claim 1, said keycap, a substrate and a connecting structure.

24. The button of claim 23, wherein:
said keycap is arranged above said composite elastomeric structure;
said substrate is arranged under said composite elastomeric structure; and
said connecting structure is used to connect said keycap and said substrate.
